(19) United States
(12) Patent Application Publication
(10) Pub. No.: US 2025/0078148 A1
(43) Pub. Date: Mar. 6, 2025

(54) Rental System and Method of Renting Outdoor Properties

(71) Applicant: David Borota, Cinnaminson, NJ (US)

(72) Inventor: David Borota, Cinnaminson, NJ (US)

(21) Appl. No.: 18/430,799

(22) Filed: Feb. 2, 2024

Related U.S. Application Data
(60) Provisional application No. 63/579,110, filed on Aug. 28, 2023.

(51) Int. Cl. G06Q 30/0645; G06Q 50/163

(52) U.S. Cl. CPC G06Q 30/0645; G06Q 50/163

(57) ABSTRACT

The present invention relates to a backyard rental system and an associated application or website. The system enables homeowners to publicly list their outdoor areas for temporary rental in the system using the application or website. The homeowner can include a plurality of attributes/amenities of their property including but not limited to location, booking availability, booking time, rent/fees, guests' restriction, and more. The prospective lessees can search for listed outdoor areas to rent and book a property. An agreement is signed between the homeowner and the lessee and an insurance agreement is provided between the homeowner and the lessee. The system enables homeowners/lessors to earn extra income while enabling lessees to temporarily rent outdoor places.

### CROSS-REFERENCE TO RELATED APPLICATION

The present application claims priority to, and the benefit of, U.S. Provisional Application No. 63/579,110, which was filed on Aug. 28, 2023 and is incorporated herein by reference in its entirety.

### FIELD OF THE INVENTION

The present invention generally relates to the field of renting outdoor properties of a home for organizing parties, reunions, picnics, and more. More specifically, the present invention relates to a novel system and method for enabling homeowners to list their outdoor properties on a marketplace along with attributes that are used by lessees for renting the property temporarily. The system can be used by both homeowners and lessees and includes an agreement between both the parties and an insurance carrier for the homeowner. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals like outdoor social events, such as cookouts, birthday parties, and pool parties. Such activities are popular among individuals of all ages and genders. Outdoor settings offer a more relaxed and spacious environment, which is appealing for such gatherings. However, individuals who live in apartments or densely populated urban areas often face space limitations. Properties at such locations have limited size and the space constraints make it difficult to host events such as parties or social gatherings, as their living quarters may not provide sufficient room or amenities. One alternative for hosting events is using hotel spaces. However, hotel spaces can be expensive and may not offer the flexibility and customization that a private outdoor space can provide. Many individuals travel significant distances to find public settings, but it can be tedious and expensive. Individuals often seek more personalized and cost-effective options for their gatherings.

Homeowners with large properties often have outdoor spaces such as backyards that are underutilized. Maintaining unused spaces can be costly, and homeowners may seek ways to monetize such spaces. Currently, no streamlined system or platform exists for connecting individuals who want to rent outdoor spaces temporarily with homeowners who have spaces to offer. Currently, most of the awareness about such rental opportunities is spread through word of mouth or personal networks, which is not efficient or far-reaching. Further, such renting is not safe and individuals can cause damage to property without any accountability. Individuals are looking for a system to connect homeowners (i.e., lessor) who can rent space and individuals who want to rent out (i.e., lessee), whether it's for a few hours or a couple of days.

Therefore, there exists a long felt need in the art for an online marketplace for homeowners, landlords, and lessors to rent out their property for different outdoor events. Additionally, there is a long felt need in the art for platform that enables homeowners to rent out their backyard, pools, playgrounds, and other outdoor areas to others easily and safely. Moreover, there is a long felt need in the art for a system that offers a way of generating additional income for landlords and homeowners by temporarily renting out unused outdoor spaces. Further, there is a long felt need in the art for an improved system that enables both landlords and lessees to connect with each other in a safe and convenient manner. Furthermore, there is a long felt need in the art for a system that enables individuals to rent out additional amenities along with a property to generate additional revenue. Finally, there is a long felt need in the art for a platform that enables landlords and lessors to publicly list their properties for renting out temporarily to generate income from their unused property.

The subject matter disclosed and claimed herein, in one embodiment thereof, comprises a backyard rental system to enable homeowners and property owners to list outdoor areas for rent temporarily to generate revenue. The system is accessible using a smartphone application or website and includes a home owner interface for listing properties on a marketplace, a lessee interface for renting out one or more listed properties, a homeowner database for storing profiles of homeowners, a backyard property database for storing attributes of the properties, and a module for the creation and signing of agreements between the lessees and the homeowners. A payment module for the payment process for lessees including a commission-based revenue model for the system. The system uses property attributes for selection wherein the attributes are selected from a group of customized rentals, availability days and time, and amenities, wherein optional amenities are added based on availability at the property.

In this manner, the backyard rental system of the present invention accomplishes all of the forgoing objectives and provides a smartphone application and website to allow homeowners to list their properties to rent out temporarily along with additional amenities. The system enables homeowners to generate revenue from unused or idle property and enables them to set conditions of use of the property. Lessees can select a property for an outdoor activity and pay the rent along with signing an agreement.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a backyard rental system to enable homeowners and property owners to list outdoor areas for rent. The system comprising a home owner interface for listing properties on a marketplace, a lessee interface for renting out one or more listed properties, a homeowner database for storing profiles of homeowners, a backyard property database for storing attributes of the properties, and a module for the creation and signing of agreements between the lessees and the homeowners or lessors. A payment module for the payment process for lessees including a commission-based revenue model for the system. The system includes a smartphone application for homeowners and lessees wherein the property attributes are selected from a group of customized rent, availability days and time, and amenities, wherein optional amenities are added based on availability at the property.

In yet another embodiment, the marketplace offers an available days option to enable homeowners to select specific days when their property is available for rent and an availability window option to define the start and end days/times for property rental. A buffer time option enables the homeowner to set a buffer period between consecutive bookings.

In yet another embodiment, a backyard rental system is disclosed. The system comprising a property owner interface for creating profile of a homeowner, the profile is stored in a homeowner database. A property attributes interface for adding renting attributes of a property, the attributes are stored in another or a second database. A property rent interface for setting renting prices/costs depending on the number of guests. A property availability interface for setting availability time and days of the properties, wherein all the attributes are displayed along with the property in a marketplace.

In another embodiment, a computer implemented method for public listing of properties for temporarily renting (i.e., availability). The method includes the steps of adding a property to a marketplace, adding attributes of the property, selecting from a group of cost, availability time and days, amenities, and guests restrictions, displaying the property on the marketplace and renting out the property by a lessee by paying an agreed cost, wherein an agreement is signed between the homeowner and the lessee and an insurance policy is provided to the homeowner.

In yet another embodiment, the interfaces are accessed using an application or a website, wherein the interfaces are provided by a server using a communication channel.

In yet another embodiment, the system provides an agreement to both a homeowner and a lessee for signature and affirmation to include the conditions related to the property rented by a lessee and restricting lessees from being able to sue homeowners for injuries while on premises of the homeowners.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the backyard rental system of the present invention in accordance with the disclosed architecture;

FIGS. 2 and 3 illustrate exemplary user interfaces provided by the backyard rental application of the present invention for creating a homeowner profile and listing owned properties in the marketplace in accordance with the disclosed architecture;

FIG. 4 illustrates another user interface of the marketplace provided by the backyard rental application of the present invention for adding additional amenities for a property in accordance with the disclosed architecture;

FIG. 5 illustrates an exemplary user interface displayed by the rental application for enabling a homeowner to set a rental for a property based on number of guests in accordance with one embodiment of the present invention;

FIG. 6 illustrates yet another user interface displayed by the backyard rental application for enabling a homeowner to set availability details of a property in accordance with one embodiment of the present invention;

FIG. 7 illustrates a flow chart depicting a process of using the backyard rental system of the present invention for renting out properties in accordance with one embodiment of the present invention; and

FIG. 8 depicts an example user device for installing the backyard rental application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an online marketplace for homeowners and landlords to rent out their property for different outdoor events. Additionally, there is a long felt need in the art for platform that enables homeowners to rent out their backyard, pools, playgrounds, and other outdoor areas (i.e., amenities) to others easily and safely. Moreover, there is a long felt need in the art for a system that offers a way of generating additional income for landlords and homeowners by temporarily renting out unused outdoor spaces. Further, there is a long felt need in the art for an improved system that enables both landlords and lessees to connect with each other in a safe and convenient manner. Furthermore, there is a long felt need in the art for a system that enables individuals to rent out additional amenities along with a property to generate additional revenue. Finally, there is a long felt need in the art for a platform that enables landlords to publicly list their properties for renting out temporarily to generate income from their unused property.

The present invention, in one exemplary embodiment, is a computer implemented method for public listing of properties for temporarily renting out. The method includes the steps of adding a property to a marketplace, adding attributes of the property, selecting from a group of cost, availability time and days, amenities, and guests restrictions, displaying the property on the marketplace and renting out the property by a lessee by paying an agreed cost, wherein an agreement is signed between the homeowner and the lessee and an insurance policy is provided to the homeowner.

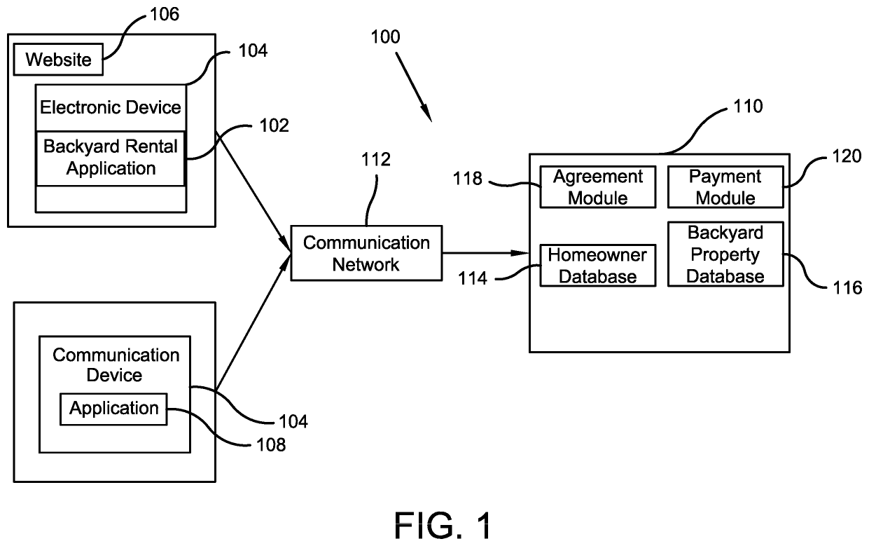

Referring initially to the drawings, FIG. 1 illustrates a schematic view of the backyard rental system of the present invention in accordance with the disclosed architecture. The backyard or private residence rental system 100 of the present invention is designed to provide an online marketplace that enables homeowners and property owners to list their outdoor areas such as pools, backyards, front yards, and more for rental for a specific duration and at a specific cost. More specifically, the marketplace can be accessed through a smartphone application or a website to allow homeowners to make their listings public while enabling lessees to rent a chosen property as per their preferences and requirements. The system 100 provides insurance to homeowners for property damage or injury by lessees while also restricting lessees from damaging property and injuring individuals.

The marketplace is accessed by homeowners/landlords/lessors using a smartphone backyard rental application 102 installed in a user electronic device 104. The marketplace can also be accessed using a website 106 accessible on a browser on the user electronic device 104. The marketplace enables lessees to see the properties listed by the homeowners/lessors using the software application 108. It will be noted that the software application 108 can be the same or different from the application 102 or website 106 used by the homeowners. The list viewed by a lessee can be shortlisted or filtered based on different parameters such as location, type of property, amenity, and more as described later in the disclosure.

The applications 102, 108 are configured to connect to a server 110 using a communication network 112. The server 110 is adapted to provide marketplace offered by the system 100. The server 110 also provides different user interfaces for homeowners and lessees to interact with the marketplace. The communication network 112 can be one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), wideband CDMA (WCDMA), CDMA 2000, discrete multi-tone (DMT), Bluetooth (®), global positioning system (GPS), Wi-Fi, ZigBee™, global system for mobile communication (GSM), 2G, 2.5G, 3G, 3.5G, 4G, 5G, 6G or the like.

The server 110 includes a homeowner database 114 for storing information of the registered homeowners. The server 110 can store names, contact details, property names and more and can be used for correlating one or more properties with a homeowner. A backyard property database 116 includes different attributes of a property enabling a lessee to filter and select the property. In an embodiment, photos, location, space details, amenities, pricing, booking availability, number of guests and more can be associated with a property. A homeowner can select one or more properties listed by the homeowner using the marketplace. The property database 116 can also include additional space/amenity details such as a pool, a playground, a sauna, an outdoor kitchen, a covered eating area, a hot tub, a playing court, and more of a property for easy selection by a lessee.

An agreement module 118 is adapted to provide an agreement to both a homeowner and a lessee for signature and agreement to include the conditions related to the property rented by a lessee and restricting lessees from being able to sue homeowners for injuries while on premises of the homeowners. Further, the agreement module 118 can provide an insurance policy for the homeowners for property damage.

A payment module 120 enables the lessees to perform payment for renting out a property using the system 100. The payment module 120 also facilitates the property owners to receive payments made by the lessees. In some embodiments, a commission can be deducted from payment made by a lessee as a commission for revenue generation by the system 100.

It will be apparent to a person skilled in the art that the property rental system 100 enables homeowners to create listings for their outdoor spaces, including photos and descriptions. Further, the landlords can set rental prices, such as on an hourly basis or on a fixed amount basis. The unused outdoor property rental system 100 provides a new avenue for homeowners to earn extra income by utilizing their unused outdoor spaces while keeping their homes private and secure.

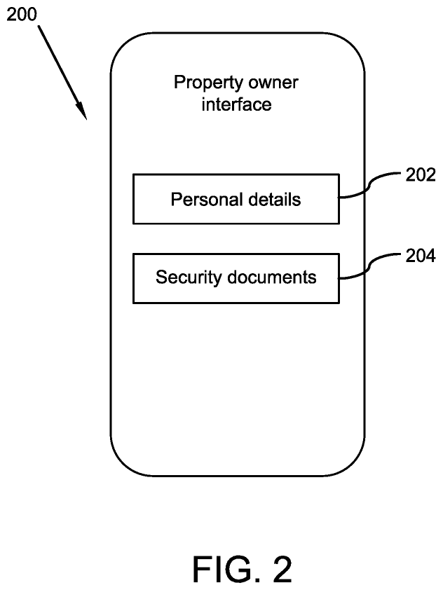

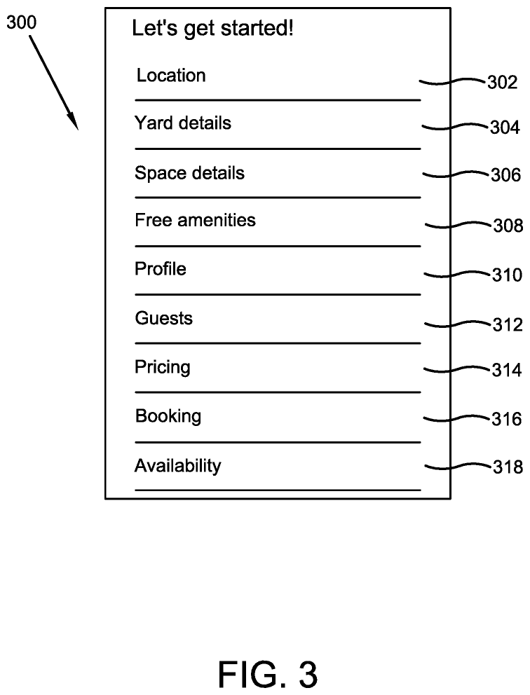

FIGS. 2 and 3 illustrate exemplary user interfaces provided by the backyard rental application of the present invention for creating a homeowner profile and listing owned properties in the marketplace in accordance with the disclosed architecture. As illustrated in FIG. 2, a homeowner registers into the unused outdoor property temporary rental system 100 using property owner interface 200 by providing personal details 202 and by providing security documents 204 for authentication and background check. Then, as using the property attributes database 300 as illustrated in FIG. 3, location for a property is selected using the location option 302 and pool details are added using the pool details option 304. Space details such as size, shape, floors, and more are added using the space details option 306. Free amenities offered at the property are added by the homeowner using the free amenities option 308. Profile of the homeowner is attached to the property using the profile option 310. The attachment of the profile enables lessees to view the details of the homeowner along with the details of property.

The number of guests that can be accommodated in the property is selected using the guests option 312. Additional details, such as whether children allowed or not allowed can also be included using the guests option 312. An advantage of the present invention is the setting of the rent of a property by the homeowner using the Pricing option 314. The pricing option 314 may provide different ways of setting the pricing such as on an hourly basis, a fixed cost or an EMI based option.

Booking option 316 can include booking time, booking days, booking conditions that are set by the homeowner. The booking details can also be used for filtering properties based on the criteria set by a lessee for renting out the properties using the marketplace. The availability option 318 enables a homeowner to check the availability of the property for a duration or alternatively enables the homeowner to update the availability of the property.

All the attributes for a property are stored in the property database 116 and can be identified by a unique identifier of the property. Furthermore, the registered property is also associated with the homeowner profile.

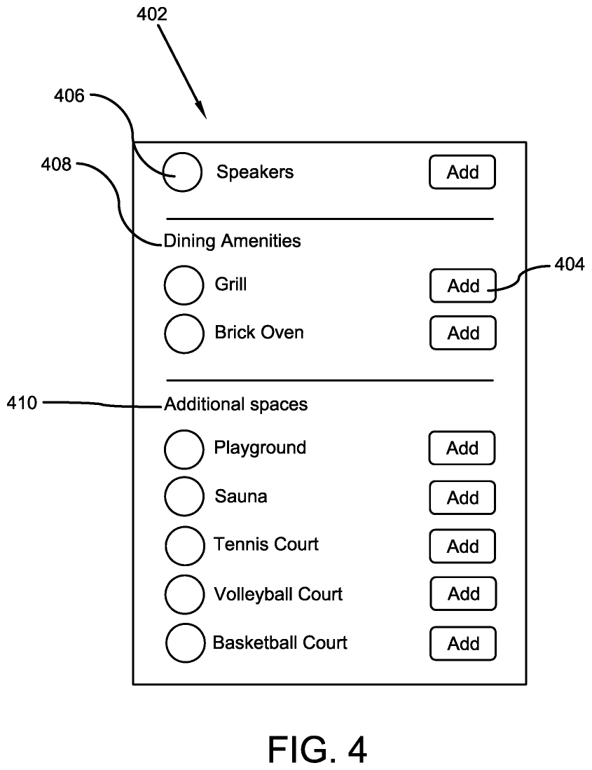

FIG. 4 illustrates another user interface of the marketplace provided by the backyard rental application of the present invention for adding additional amenities for a property in accordance with the disclosed architecture. As illustrated, the system 100 provides an option for a homeowner to add optional amenities 402 based on their availability for a property. The additional amenities increase chances of selection of the property by a lessee. An “Add” option 404 is provided for a plurality of amenities including additional amenities 406, dining amenities 408 and additional spaces 410. Based on availability of the amenities at a property, a homeowner can select amenities. In some embodiments, the cost of the property is adjusted based on the associated amenities.

It should be noted that a lessee is also presented the user interface 402, wherein based on their preferences, one or more amenities can be added when renting the property. Only the amenities that are available at the property are visible to a lessee with the option to add/reserve the amenities.

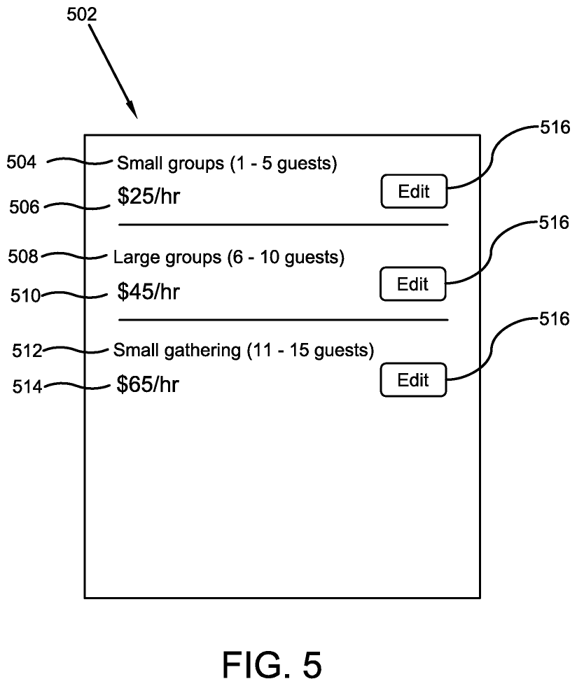

FIG. 5 illustrates an exemplary user interface displayed by the rental application 102 for enabling a homeowner to set a rental for a property based on number of guests in accordance with one embodiment of the present invention. A homeowner using the rent setting interface 502 can set different prices for different number of guests for a property. As illustrated as an example, for a small group 504, a first cost 506 is set which is further editable and can be reset as per desire of the homeowner. For large group 508, another price 510 can be set and for a small gathering 512, a different price 514 is set. All the prices in the application 102 can be reset and further can be edited using corresponding Edit button 516.

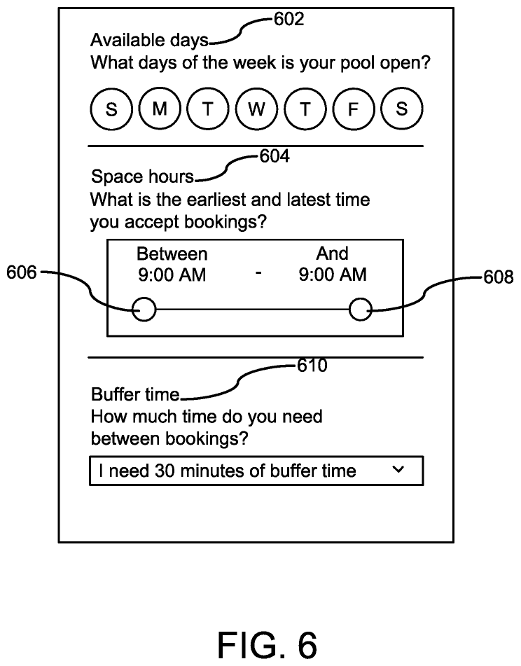

FIG. 6 illustrates yet another user interface displayed by the backyard rental application 102 for enabling a homeowner to set availability details of a property in accordance with one embodiment of the present invention. Using the Available days option 602 the homeowner can select one or more days on which the property is available for renting out. The option 602 can be separately and independently provided for each property and amenities at the property.

An availability window 604 is used for selecting starting time 606 and end time 608 for which the property is available for renting out. A homeowner can select any window as per the preferences and the cost for renting out can automatically be calculated for the renting duration. A buffer time option 610 enables a user to select a buffer time between two consecutive bookings enabling the homeowner to clean and maintain the property for the next booking.

It will be apparent to a person skilled in the art that the system 100 also provides similar interfaces for selecting one or more properties for renting out. A list of properties based on parameters such as location of the lessee, profile of the lessee and more is displayed to the lessee for renting out.

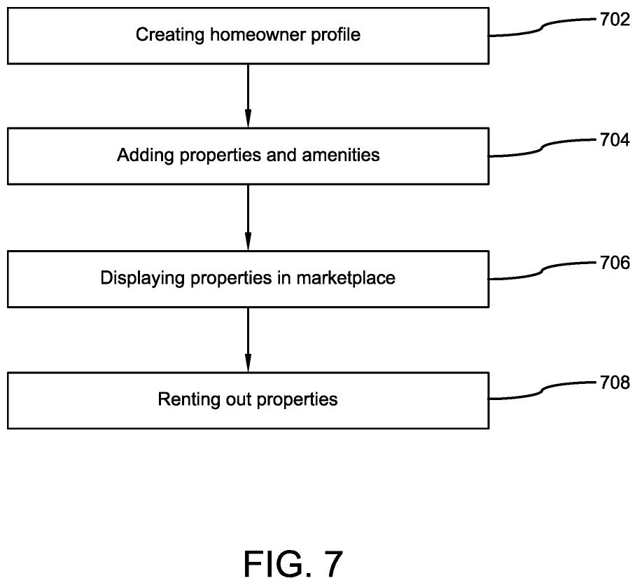

FIG. 7 illustrates a flow chart depicting a process of using the backyard rental system of the present invention for renting out properties in accordance with one embodiment of the present invention. Initially, a profile is created by a homeowner using the application or the website (Step 702). Then, one or more properties and associated booking timings, amenities and more are added to the system for displaying in the marketplace (Step 704). Thereafter, the properties are displayed in the marketplace for lessees where one or more properties can be selected by a lessee for renting out (Step 706). Finally, the lessee pays out the calculated rent for the property and completes the booking for a specific time and duration (Step 708).

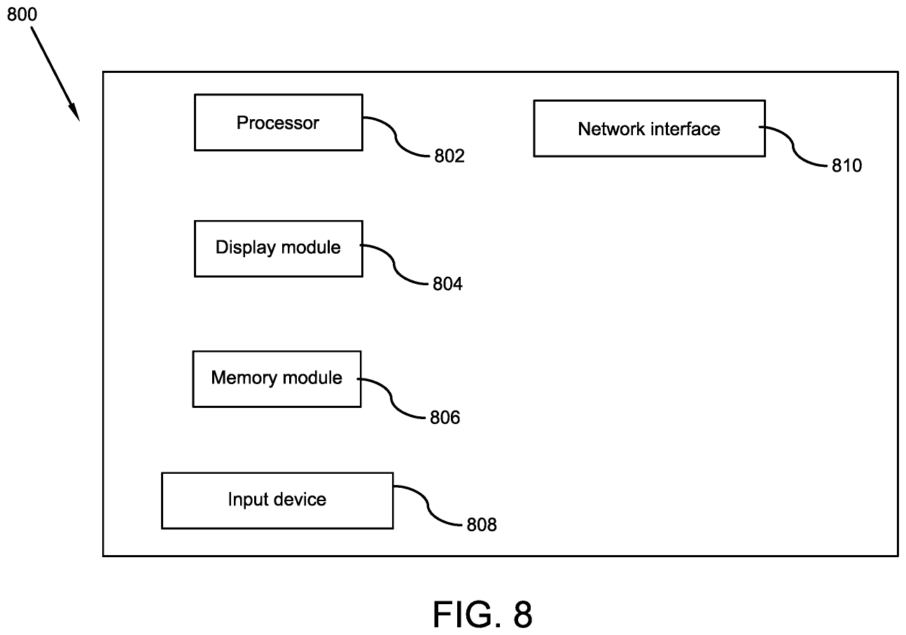

FIG. 8 depicts an example user device for installing the backyard rental application of the present invention in accordance with the disclosed architecture. The user device 800 may be implemented on a handheld device, smart phone, laptop, or desktop computer and more as described in FIG. 1. The user device 800 includes a processor 802 communicatively coupled to one or more memory modules 806. The processor 802 executes computer-executable program code of the application stored in the memory device 806. Examples of the processor 802 include a microprocessor, an application-specific integrated circuit (“ASIC”), a field-programmable gate array (“FPGA”), or any other suitable processing device. The processor 802 can include any number of processing devices or cores, including a single processing device. The functionality of the computing device may be implemented in hardware, software, firmware, or a combination thereof.

The memory module 806 includes any suitable computer-readable medium such as electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions.

The computing device 800 executes program code that configures the processor 802 to perform one or more of the operations described earlier in the disclosure. The computing device 800 also includes at least one network interface 810. The network interface 810 includes any device or group of devices suitable for establishing a wired or wireless data connection to one or more data networks. Non-limiting examples of the network interface 810 include an Ethernet network adapter, a modem, or the like.

A display module 804 is configured for displaying user interfaces of the application of the present invention and the input device 808 can be used for submitting input to the application for processing by the processor 802.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “unused outdoor property rental system”, “backyard rental system”, “rental system”, “system”, “unused outdoor property temporary rental system”, and “property rental system” are interchangeable and refer to the unused outdoor property temporary rental system 100 of the present invention.

Notwithstanding the forgoing, the unused outdoor property temporary rental system 100 of the present invention can be of any suitable size and configuration as is known in the art without affecting the overall concept of the invention, provided that it accomplishes the above stated objectives. One of ordinary skill in the art will appreciate that the unused outdoor property temporary rental system 100 as shown in the FIGS. are for illustrative purposes only, and that many other configurations of the unused outdoor property temporary rental system 100 can be included in the present invention.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rental system comprising:
a server having a lessor portal into an online rental system for listing a rental residence and a lessee portal into said online rental system for renting said rental residence;
a communication network; and
wherein said listing of said rental residence having a selectable duration including a per hour rental fee, a per day rental fee, and a fixed fee;
wherein said listing of said rental residence having an insurance agreement for agreement by said lessee;
wherein said rental residence having an availability and a listing of amenities identifiable with said rental residence including an amenity fee associated with each of said listing of amenities;
wherein at least one amenity of said listing of amenities selectable by said lessee; and
further wherein said listing of amenities selected from the group consisting of a backyard, a front yard, a pool, a playground, a sauna, an outdoor kitchen, a covered eating area, a hot tub, a playing court, and a playground.

2. The rental system of claim 1, wherein said selectable duration having a selectable number of hours.

3. The rental system of claim 2, wherein said selectable duration having a selectable number of days.

4. The rental system of claim 3, wherein said lessor portal accessible using a rental residence application installed in a user electronic device.

5. The rental system of claim 4, wherein said lessee portal accessible using said rental residence application installed in another user electronic device.

6. The rental system of claim 5, wherein said listing of said rental residence having a filter for filtering said listing of said rental residence by location.

7. The rental system of claim 5, wherein said listing of said rental residence having a filter for filtering said listing of said rental residence by amenity.

8. The rental system of claim 7, wherein said communication network having a wireless communication signal selected from the group consisting of a radio frequency (RF), an infrared (IR), a frequency-division multiplexing (FDM), an orthogonal FDM (OFDM), a time-division multiplexing (TDM), a time-division multiple access (TDMA), an extended TDMA (E-TDMA), a wideband CDMA (WCDMA), a CDMA 2000, a discrete multi-tone (DMT), a Bluetooth (®), a global positioning system (GPS), a Wi-Fi, ZigBee™, and a global system for mobile communication (GSM).

9. The rental system of claim 5, wherein said server having a lessor database including lessor information selected from the group consisting of a lessor name, a lessor contact detail, a rental residence name, a rental residence photo, a rental residence space detail, a pricing per amenity, a rental residence booking availability, and a guest capacity.

10. The rental system of claim 9, wherein said server having an agreement module including an agreement document between said lessor and said lessee and conditions associated with said rental residence.

11. The rental system of claim 10, wherein said server having a payment module for accepting payment from said lessee and transferring said payment to said lessor.

12. The rental system of claim 11, wherein said server deducting a commission from said payment for revenue generation for said rental system.

13. A rental system comprising:
a server having a lessor portal into an online rental system for listing a rental residence and a lessee portal into said online rental system for renting said rental residence;
a communication network; and
wherein said listing of said rental residence having a selectable pricing option fee including a per hour rental fee, a per day rental fee, and a fixed fee;
wherein said listing of said rental residence having an insurance agreement for agreement by said lessee;
wherein said rental residence having an availability and a listing of amenities identifiable with said rental residence including an amenity fee associated with each of said listing of amenities;
wherein at least one amenity of said listing of amenities selectable by said lessee;
wherein said listing of amenities selected from the group consisting of a backyard, a front yard, a pool, a playground, a sauna, an outdoor kitchen, a covered eating area, a hot tub, a playing court, and a playground; and
further wherein said listing of said rental residence having a filter for filtering said listing of said rental residence by amenity and by location.

14. The rental system of claim 13, wherein said selectable pricing option fee having a selectable number of hours.

15. The rental system of claim 13, wherein said selectable pricing option fee having a selectable number of days.

16. The rental system of claim 13, wherein said lessor portal and said lessee portal accessible using a rental residence application installed in a user electronic device.

17. The rental system of claim 13, wherein said server having a lessor database including lessor information selected from the group consisting of a lessor name, a lessor contact detail, a rental residence name, a rental residence photo, a rental residence space detail, a pricing per amenity, a rental residence booking availability, and a guest capacity.

18. The rental system of claim 17, wherein said server having a payment module for accepting payment from said lessee and transferring said payment to said lessor.

19. The rental system of claim 18, wherein said server deducting a commission from said payment for revenue generation for said rental system.

20. A rental system comprising:
a server having a lessor portal into an online rental system for listing a rental residence and a lessee portal into said online rental system for renting said rental residence;
a communication network; and
wherein said listing of said rental residence having a pricing option selected from the group consisting of a per hour rental fee, a per day rental fee, a fixed fee, an amenity fee, and a number of guests fee;
wherein said listing of said rental residence having an insurance agreement for agreement by said lessee;
wherein said rental residence having an availability and a listing of amenities identifiable with said rental residence including said amenity fee associated with each of said listing of amenities;
wherein at least one amenity of said listing of amenities selectable by said lessee;
wherein said listing of amenities selected from the group consisting of a backyard, a front yard, a pool, a playground, a sauna, an outdoor kitchen, a covered eating area, a hot tub, a playing court, and a playground; and
further wherein said pricing option including said number of guests fee based on a number of guests of said lessee.
